(19) United States
(12) Patent Application Publication
(10) Pub. No.: US 2025/0336368 A1
(43) Pub. Date: Oct. 30, 2025

(54) DISPLAY SYSTEM AND ELECTRONIC APPARATUS INCLUDING THE SAME

(71) Applicants: Samsung Display Co., LTD., Yongin-si (KR); AnaPass Inc., Seoul (KR)

(72) Inventors: JIWOONG KIM, Yongin-si (KR); Dowan Kim, Seoul (KR); Joonbae Park, Seoul (KR); OHJO KWON, Yongin-si (KR); Yongjae Lee, Yongin-si (KR)

(21) Appl. No.: 19/193,055

(22) Filed: Apr. 29, 2025

(30) Foreign Application Priority Data
Apr. 30, 2024 (KR) 10-2024-0058098

(51) Int. Cl. G09G 3/3275; G09G 3/00

(52) U.S. Cl. CPC G09G 3/3275; G09G 3/006; G09G 3/001; G09G 2310/027; G09G 2310/0286; G09G 2310/0291; G09G 2320/02; G09G 2330/021

(57) ABSTRACT

A display system includes a display panel, a data driver and an offset apparatus. The data driver outputs a data voltage to the display panel. The offset apparatus includes an offset measurer configured to receive a sensing voltage from the data driver and to measure offsets of output amplifiers of the data driver. The data driver includes an offset storer configured to store the offsets of the output amplifiers and an offset compensator configured to receive the offsets of the output amplifiers and to compensate a data signal.

This application claims priority to Korean Patent Application No. 10-2024-0058098, filed on Apr. 30, 2024, and all the benefits accruing therefrom under 35 U.S.C. § 119, the content of which in its entirety is herein incorporated by reference.

### BACKGROUND

### 1. Field

Embodiments of the inventive concept relate to a display system, a display apparatus and an electronic apparatus including the display system. More particularly, embodiments of the inventive concept relate to a display system enhancing a display quality of a display panel by compensating an offset of an output amplifier of a data driver, a display apparatus and an electronic apparatus including the display system.

### 2. Description of the Related Art

Generally, a display apparatus includes a display panel and a display panel driver. The display panel includes a plurality of gate lines, a plurality of data lines and a plurality of pixels. The display panel driver includes a gate driver, a data driver and a driving controller. The gate driver outputs gate signals to the gate lines. The data driver outputs data voltages to the data lines. The driving controller controls an operation of the gate driver and an operation of the data driver.

### SUMMARY

Offset differences of output amplifiers of the data driver may occur due to process differences between elements included in the output amplifiers of the data driver. When sizes of transistors of the output amplifiers of the data driver are increased to reduce the offset differences, an output speed of the output amplifier may decrease, a space may be limited and a manufacturing cost may increase. When a current is increased to prevent the decrease of the output speed of the output amplifier, the power consumption may increase.

Embodiments of the inventive concept provide a display system enhancing a display quality of a display panel by compensating an offset of an output amplifier of a data driver.

Embodiments of the inventive concept provide a display apparatus enhancing the display quality of the display panel by compensating the offset of the output amplifier of the data driver.

Embodiments of the inventive concept provide an electronic apparatus including the display system.

In an embodiment of a display system according to the inventive concept, the display system includes a display panel, a data driver and an offset apparatus. The data driver outputs a data voltage to the display panel. The offset apparatus includes an offset measurer which receives a sensing voltage from the data driver and measures offsets of output amplifiers of the data driver. The data driver includes an offset storer which stores the offsets of the output amplifiers and an offset compensator which receives the offsets of the output amplifiers and compensates a data signal.

In an embodiment, the offset measurer may measure the offsets of all of the output amplifiers of the data driver. The offset storer may store the offsets of all of the output amplifiers of the data driver.

In an embodiment, the offset apparatus may further include an offset determiner which receives the offsets of the output amplifiers from the offset measurer and determines whether the offsets are outside a predetermined tolerance range.

In an embodiment, the offset measurer may measure the offsets of all of the output amplifiers of the data driver. The offset storer may store only an offset of an output amplifier which is outside the predetermined tolerance range among the offsets of all of the output amplifiers of the data driver.

In an embodiment, the data driver may further include a shift register which receives a compensated data signal, a latch which temporally stores the compensated data signal, a digital-to-analog converting circuit which converts the compensated data signal to the data voltage having an analog type and an output amplifying circuit which outputs the data voltage to the display panel. The offset compensator may output the compensated data signal to the shift register. The offset measurer may receive the sensing voltage from the output amplifying circuit.

In an embodiment, the data driver may further include a first output amplifier, a second output amplifier, a first data line, a second data line, an 1-1 switch disposed between the first output amplifier and the first data line, an 1-2 switch disposed between the first output amplifier and the second data line, a 2-1 switch disposed between the second output amplifier and the first data line and a 2-2 switch disposed between the second output amplifier and the second data line.

In an embodiment, the first output amplifier may be connected to the first data line and the second output amplifier may be connected to the second data line in a first mode. The first output amplifier may be connected to the second data line and the second output amplifier may be connected to the first data line in a second mode. The first mode and the second mode may alternately operate.

In an embodiment of an electronic apparatus according to the inventive concept, the electronic apparatus includes a display panel, a data driver, a driving controller and a processor. The data driver outputs a data voltage to the display panel. The data driver includes an offset measurer which receives a sensing voltage from output amplifiers and measures offsets of the output amplifiers, an offset storer which stores the offsets of the output amplifiers and an offset compensator which receives the offsets of the output amplifiers and compensates a data signal. The driving controller controls the data driver. The processor outputs input image data and an input control signal to the driving controller.

In an embodiment, the offset measurer may measure the offsets of all of the output amplifiers of the data driver. The offset storer may store the offsets of all of the output amplifiers of the data driver.

In an embodiment, the data driver may further include an offset determiner which receives the offsets of the output amplifiers from the offset measurer and determines whether the offsets are outside a predetermined tolerance range.

In an embodiment, the offset measurer may measure the offsets of all of the output amplifiers of the data driver. The offset storer may store only an offset of an output amplifier which is outside the predetermined tolerance range among the offsets of all of the output amplifiers of the data driver.

In an embodiment, the data driver may output the data voltage to the display panel in a driving mode. The data driver may output the sensing voltage to the display panel in a measuring mode. The offset measurer may receive the sensing voltage in the measuring mode.

In an embodiment, the data driver may further include a shift register which receives a compensated data signal, a latch which temporally stores the compensated data signal, a digital-to-analog converting circuit which converts the compensated data signal to the data voltage having an analog type and an output amplifying circuit which outputs the data voltage to the display panel. The offset compensator may output the compensated data signal to the shift register. The offset measurer may receive the sensing voltage from the output amplifying circuit.

In an embodiment, the data driver may further include a first output amplifier, a second output amplifier, a first data line, a second data line, an 1-1 switch disposed between the first output amplifier and the first data line, an 1-2 switch disposed between the first output amplifier and the second data line, a 2-1 switch disposed between the second output amplifier and the first data line and a 2-2 switch disposed between the second output amplifier and the second data line.

In an embodiment, the first output amplifier may be connected to the first data line and the second output amplifier may be connected to the second data line in a first mode. The first output amplifier may be connected to the second data line and the second output amplifier may be connected to the first data line in a second mode. The first mode and the second mode may alternately operate.

In an embodiment of a display system according to the inventive concept, the display system includes a first display panel, a second display panel, a first data driver, a second data driver, a first offset apparatus and a second offset apparatus. The first data driver outputs a first data voltage to the first display panel. The second data driver outputs a second data voltage to the second display panel. The first offset apparatus receives a first sensing voltage from the first data driver and to measure a first offset of a first output amplifier of the first data driver. The second offset apparatus receives a second sensing voltage from the second data driver and to measure a second offset of a second output amplifier of the second data driver. At least one of the first data driver and the second data driver includes an offset storer which stores at least one of the first offset of the first output amplifier and the second offset of the second output amplifier and an offset compensator which receives at least one of the first offset of the first output amplifier and the second offset of the second output amplifier and compensates at least one of a first data signal and a second data signal.

In an embodiment, the display system may further include a first driving controller which outputs the first data signal to the first data driver and a second driving controller which outputs the second data signal to the second data driver.

In an embodiment, the display system may further include a driving controller which outputs the first data signal to the first data driver and the second data signal to the second data driver.

In an embodiment, the first display panel may be a first-eye display panel corresponding to a user's first eye. The second display panel may be a second-eye display panel corresponding to a user's second eye.

In an embodiment, the display system may further include a first-eye lens corresponding to the first-eye display panel and a second-eye lens corresponding to the second-eye display panel.

In an embodiment of an electronic apparatus according to the inventive concept, the electronic apparatus includes a display panel, a data driver, an offset apparatus, a driving controller and a processor. The data driver outputs a data voltage to the display panel. The offset apparatus includes an offset measurer which receives a sensing voltage from the data driver and measures offsets of output amplifiers of the data driver. The driving controller controls the data driver. The processor outputs input image data and an input control signal to the driving controller. The data driver includes an offset storer which stores the offsets of the output amplifiers and an offset compensator which receives the offsets of the output amplifiers and to compensate a data signal.

According to the display system, the display apparatus and the electronic apparatus including the display system, to compensate the offset differences of the output amplifiers of the data driver, the offsets of all output amplifiers of the data driver may be measured, the offsets of all output amplifiers or some output amplifiers are stored and the data signals may be compensated based on the stored offsets.

The offset differences are compensated so that a vertical line defect of the display panel may be prevented and the display quality of the display panel may be enhanced.

In addition, the sizes of the transistors of the output amplifiers of the data driver may not be increased so that the output speed of the output amplifier may not be decreased, the space may not be limited and a manufacturing cost may be reduced. In addition, the current may not be increased to prevent the decrease of the output speed of the output amplifier so that the power consumption may be reduced.

### BRIEF DESCRIPTION OF THE DRAWINGS

The above and other features and advantages of the inventive concept will become more apparent by describing in detailed embodiments thereof with reference to the accompanying drawings, in which:

FIG. 1 is a block diagram illustrating an embodiment of a display system according to the inventive concept;

FIG. 2 is a block diagram illustrating a display panel, a data driver and an offset apparatus of FIG. 1;

FIG. 3A is a circuit diagram illustrating a first output amplifier and a second output amplifier of the data driver of FIG. 2 and a first data line and a second data line of the display panel of FIG. 2;

FIG. 3B is a circuit diagram illustrating connections of the first output amplifier, the second output amplifier, the first data line and the second data line of FIG. 3A in a first mode;

FIG. 3C is a circuit diagram illustrating connections of the first output amplifier, the second output amplifier, the first data line and the second data line of FIG. 3A in a second mode;

FIG. 4 is a block diagram illustrating an embodiment of a display panel, a data driver and an offset apparatus of a display system according to the inventive concept;

FIG. 5 is a block diagram illustrating an embodiment of a display apparatus according to the inventive concept;

FIG. 6 is a block diagram illustrating a display panel and a data driver of FIG. 5;

FIG. 7 is a block diagram illustrating an embodiment of a display panel and a data driver of a display apparatus according to the inventive concept;

FIG. 8 is a diagram illustrating an embodiment of a display system according to the inventive concept;

FIG. 9 is a block diagram illustrating the display system of FIG. 8;

FIG. 10 is a diagram illustrating an embodiment of a display system according to the inventive concept;

FIG. 11 is a block diagram illustrating an embodiment of an electronic apparatus according to the inventive concept; and

FIG. 12 is a diagram illustrating an embodiment in which the electronic apparatus of FIG. 11 is implemented as a smartphone.

### DETAILED DESCRIPTION

Hereinafter, the inventive concept will be explained in detail with reference to the accompanying drawings.

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it may be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” may therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” may, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). The term such as “about” may mean within one or more standard deviations, or within +30%, 20%, 10%, 5% of the stated value, for example.

The terms such as “storer” “compensator,” “measurer” and “determiner” as used herein are intended to mean a hardware component such as a circuitry that performs a predetermined function. The hardware component may include a field-programmable gate array (“FPGA”) or an application-specific integrated circuit (“ASIC”), for example.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

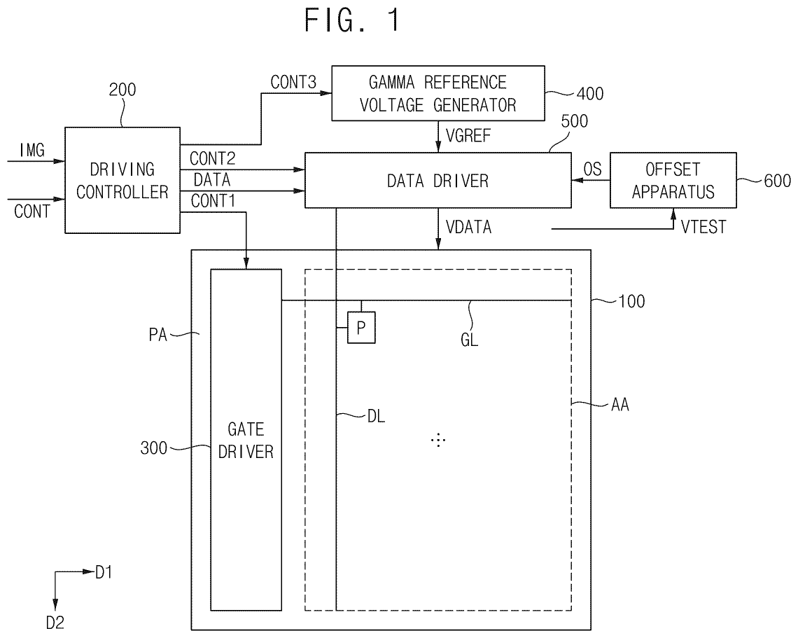

FIG. 1 is a block diagram illustrating an embodiment of a display apparatus according to the inventive concept.

Referring to FIG. 1, the display system includes a display apparatus and an offset apparatus 600. The display apparatus includes a display panel 100 and a display panel driver. The display panel driver drives the display panel 100. The display panel driver includes a driving controller 200, a gate driver 300, a gamma reference voltage generator 400 and a data driver 500.

In an embodiment, the driving controller 200 and the data driver 500 may be unitary, for example. In an embodiment, the driving controller 200, the gamma reference voltage generator 400 and the data driver 500 may be unitary, for example. A driving module including at least the driving controller 200 and the data driver 500 which are unitary may be referred to as to a timing controller embedded data driver (“TED”).

The display panel 100 has a display region AA on which an image is displayed and a peripheral region PA next (adjacent) to the display region AA.

The display panel 100 includes a plurality of gate lines GL, a plurality of data lines DL and a plurality of pixels P electrically connected to the gate lines GL and the data lines DL. The gate lines GL may extend in a first direction D1 and the data lines DL may extend in a second direction D2 crossing the first direction D1.

The driving controller 200 receives input image data IMG and an input control signal CONT from an external apparatus (e.g., a host, a set apparatus or an application processor). In an embodiment, the input image data IMG may include red image data, green image data and blue image data, for example. In an embodiment, the input image data IMG may include white image data, for example. In an embodiment, the input image data IMG may include magenta image data, yellow image data and cyan image data, for example. The input control signal CONT may include a master clock signal and a data enable signal. The input control signal CONT may further include a vertical synchronizing signal and a horizontal synchronizing signal.

The driving controller 200 generates a first control signal CONT1, a second control signal CONT2, a third control signal CONT3 and a data signal DATA based on the input image data IMG and the input control signal CONT.

The driving controller 200 generates the first control signal CONT1 for controlling an operation of the gate driver 300 based on the input control signal CONT, and outputs the first control signal CONT1 to the gate driver 300. The first control signal CONT1 may include a vertical start signal and a gate clock signal.

The driving controller 200 generates the second control signal CONT2 for controlling an operation of the data driver 500 based on the input control signal CONT, and outputs the second control signal CONT2 to the data driver 500. The second control signal CONT2 may include a horizontal start signal and a load signal.

The driving controller 200 generates the data signal DATA based on the input image data IMG. The driving controller 200 outputs the data signal DATA to the data driver 500.

The driving controller 200 generates the third control signal CONT3 for controlling an operation of the gamma reference voltage generator 400 based on the input control signal CONT, and outputs the third control signal CONT3 to the gamma reference voltage generator 400.

The gate driver 300 generates gate signals driving the gate lines GL in response to the first control signal CONT1 received from the driving controller 200. The gate driver 300 outputs the gate signals to the gate lines GL. In an embodiment, the gate driver 300 may sequentially output the gate signals to the gate lines GL, for example. In an embodiment, the gate driver 300 may be disposed (e.g., mounted) on the peripheral region PA of the display panel 100, for example. In an embodiment, the gate driver 300 may be integrated on the peripheral region PA of the display panel 100, for example.

The gamma reference voltage generator 400 generates a gamma reference voltage VGREF in response to the third control signal CONT3 received from the driving controller 200. The gamma reference voltage generator 400 provides the gamma reference voltage VGREF to the data driver 500.

In an embodiment, the gamma reference voltage generator 400 may be disposed in the driving controller 200, or in the data driver 500.

The data driver 500 receives the second control signal CONT2 and the data signal DATA from the driving controller 200, and receives the gamma reference voltages VGREF from the gamma reference voltage generator 400. The data driver 500 converts the data signal DATA into data voltages having an analog type using the gamma reference voltages VGREF. The data driver 500 outputs the data voltages to the data lines DL.

In an embodiment, the display apparatus in the illustrated embodiment may be a micro display apparatus including a micro organic light-emitting diode (“micro-OLED”), for example. In an embodiment, the pixel may be formed on a silicon substrate, for example. In an embodiment, the display apparatus may be the micro display apparatus including pixels formed on the silicon substrate, for example.

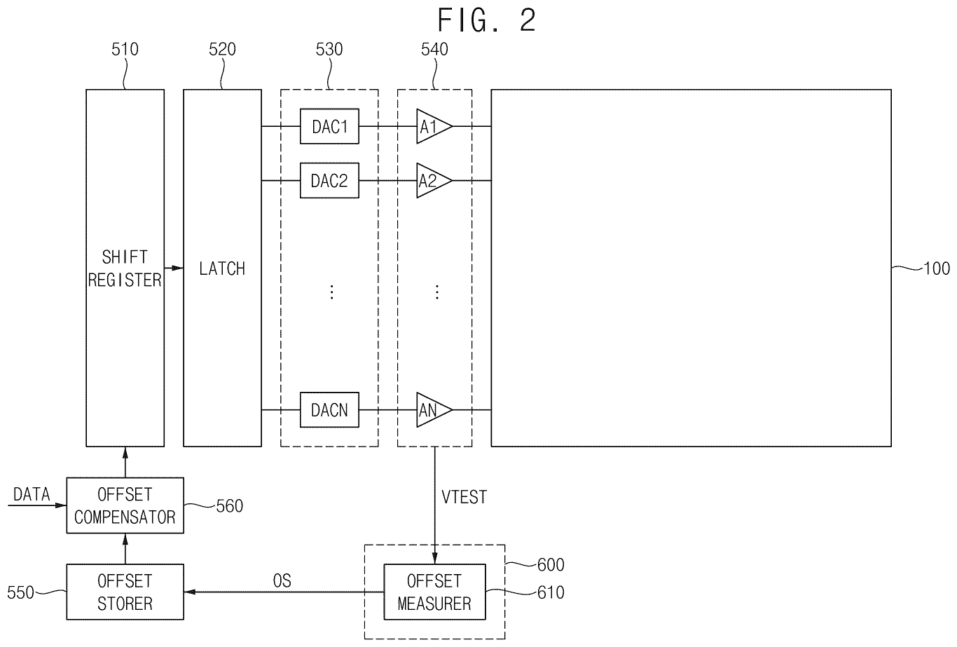

FIG. 2 is a block diagram illustrating the display panel 100, the data driver 500 and the offset apparatus 600 of FIG. 1.

Referring to FIGS. 1 and 2, the offset apparatus 600 may include an offset measurer 610. The offset measurer 610 may receive a sensing voltage VTEST from the data driver 500 and may measure offsets of output amplifiers A1, A2, . . . , AN of the data driver 500 based on the sensing voltage VTEST. Here, A1 may represent a first output amplifier, A2 may represent a second output amplifier, and AN may represent an N-th output amplifier (N may be a positive integer). In an embodiment, N may be a number of channels of the data driver 500.

In an embodiment, the offset measurer 610 may include a high-resolution analog to digital converter, for example. In an embodiment, the offset measurer 610 may be sequentially connected to the output amplifiers A1, A2, . . . , AN and measure offsets of the output amplifiers A1, A2, . . . , AN, for example.

The offset of the output amplifiers A1, A2, . . . , AN means a difference between a desired appropriate output voltage of the output amplifiers A1, A2, . . . , AN and an actual output voltage of the output amplifiers A1, A2, . . . , AN. In an embodiment, when the desired output voltage of a predetermined output amplifier (e.g., AN) is 3.0 volts (V) and the output amplifier (e.g., AN) actually outputs 3.01V, the offset of the output amplifier (e.g., AN) may be 0.01V, for example. In an embodiment, when the desired output voltage of a predetermined output amplifier (e.g., AN) is 3.0V and the output amplifier (e.g., AN) actually outputs 2.98V, the offset of the output amplifier (e.g., AN) may be −0.02V, for example.

The offsets of the output amplifiers A1, A2, AN may vary according to process differences between elements included in the output amplifiers A1, A2, . . . , AN. Due to the offset differences of the output amplifiers A1, A2, . . . , AN, a vertical line defect may occur in the display panel 100. In an embodiment, when data voltages corresponding to a display image of the entirety of the display panel 100 are 3.0V, only one output amplifier outputs a data voltage of 2.95V and the remaining output amplifiers output a data voltage of 3.0V, only the pixel row corresponding to the output amplifier outputting the data voltage of 2.95V may be shown relatively darkly or relatively brightly, for example. Accordingly, the vertical line defect may occur in the display panel 100.

In the illustrated embodiment, the offset apparatus 600 may be an external apparatus independent from the display apparatus. The offset apparatus 600 may be a test apparatus for a test of the data driver 500.

In a test step, the data driver 500 may output the sensing voltage VTEST and the offset apparatus 600 may receive the sensing voltage VTEST. In an embodiment, the sensing voltage VTEST may correspond to a white data voltage corresponding to a white image (a grayscale value of 255 out of a maximum grayscale value of 255), for example. In an embodiment, the sensing voltage VTEST may correspond to a central grayscale data voltage corresponding to a central grayscale image (a grayscale value of 127 out of a maximum grayscale value of 255), for example.

The data driver 500 may include an offset storer 550 storing the offsets OS of the output amplifiers A1, A2, . . . , AN and an offset compensator 560 receiving the offsets OS of the output amplifiers A1, A2, . . . , AN and compensating the data signal DATA based on the offsets OS.

In the illustrated embodiment, the offset storer 550 may receive the offsets OS of the output amplifiers A1, A2, . . . , AN from the offset measurer 610.

The offset compensator 560 may receive the data signal DATA from the driving controller 200. The offset compensator 560 may operate an offset compensation value having a digital type and the data signal DATA having a digital type to compensate the data signal DATA.

In the illustrated embodiment, the offset measurer 610 may measure the offsets OS of all of the output amplifiers A1, A2, . . . , AN of the data driver 500. The offset storer 550 may store the offsets OS of all of the output amplifiers A1, A2, . . . , AN of the data driver 500. In an embodiment, the offset storer 550 may store an offset of a first output amplifier A1, for example. In an embodiment, the offset storer 550 may store an offset of a second output amplifier A2, for example. In an embodiment, the offset storer 550 may store an offset of an N-th output amplifier AN, for example.

The data driver 500 may further include a shift register 510 receiving the compensated data signal DATA and shifting the compensated data signal DATA, a latch 520 temporally storing the compensated data signal DATA, a digital-to-analog converting circuit 530 converting the compensated data signal DATA to the data voltage VDATA having an analog type, and an output amplifying circuit 540 outputting the data voltage VDATA to the display panel 100.

The output amplifying circuit 540 may include the first to N-th output amplifiers A1, A2, . . . , AN. The digital-to-analog converting circuit 530 may include first to N-th digital-to-analog converters DAC1, DAC2, . . . , DACN respectively corresponding to the first to N-th output amplifiers A1, A2, . . . , AN.

The offset compensator 560 may output the compensated data signal DATA to the shift register 510. The offset measurer 610 may receive the sensing voltage VTEST from the output amplifying circuit 540.

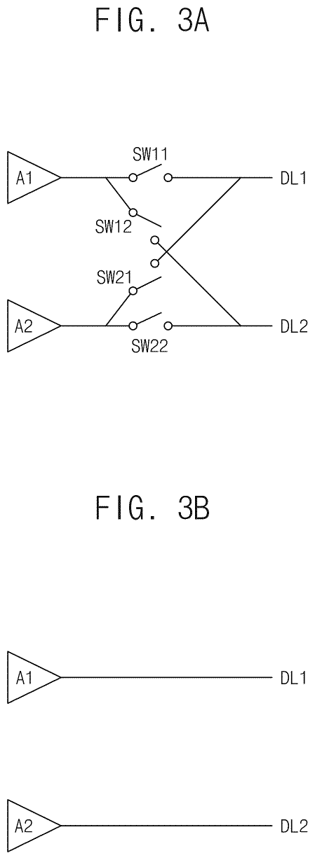

FIG. 3A is a circuit diagram illustrating the first output amplifier A1 and the second output amplifier A2 of the data driver 500 of FIG. 2 and a first data line DL1 and a second data line DL2 of the display panel 100 of FIG. 2. FIG. 3B is a circuit diagram illustrating connections of the first output amplifier A1, the second output amplifier A2, the first data line DL1 and the second data line DL2 of FIG. 3A in a first mode. FIG. 3C is a circuit diagram illustrating connections of the first output amplifier A1, the second output amplifier A2, the first data line DL1 and the second data line DL2 of FIG. 3A in a second mode.

Referring to FIGS. 1 to 3C, the data driver 500 may include the first output amplifier A1, the second output amplifier A2, the first data line DL1, the second data line DL2, an 1-1 switch SW11 disposed between the first output amplifier A1 and the first data line DL1, an 1-2 switch SW12 disposed between the first output amplifier A2 and the second data line DL2, a 2-1 switch SW21 disposed between the second output amplifier A2 and the first data line DL1 and a 2-2 switch SW22 disposed between the second output amplifier A2 and the second data line DL2.

As shown in FIG. 3B, the first output amplifier A1 may be connected to the first data line DL1 and the second output amplifier A2 may be connected to the second data line DL2 in the first mode.

As shown in FIG. 3C, the first output amplifier A1 may be connected to the second data line DL2 and the second output amplifier A2 may be connected to the first data line DL1 in the second mode.

The first mode and the second mode may alternately operate. When the first mode and the second mode alternately operate, an offset component of the first output amplifier A1 and an offset component of the second output amplifier A2 may be reflected to the data voltage outputted to the first data line DL1 and the second data line DL2 in a time division manner. Thus, an average of the data voltage of the first data line DL1 and an average of the data voltage of the second data line DL2 may not have difference. As explained above, a luminance difference of a display image between two data lines DL1 and DL2 due to the offsets of two output amplifiers A1 and A2 may be removed so that the display quality of the display panel 100 may be enhanced.

For convenience of explanation, only the first output amplifier A1, the second output amplifier A2, the first data line DL1 and the second data line DL2 are explained in the illustrated embodiment. However, odd-numbered output amplifiers of the data driver 500 may operate like the first output amplifier A1 of the illustrated embodiment and even-numbered output amplifiers of the data driver 500 may operate like the second output amplifier A2 of the illustrated embodiment.

In the illustrated embodiment, to compensate the offset differences of the output amplifiers of the data driver 500, the offsets of all output amplifiers of the data driver 500 may be measured, the offsets of all output amplifiers are stored and the data signals DATA may be compensated based on the stored offsets.

The offset differences are compensated so that the vertical line defect of the display panel 100 may be prevented and the display quality of the display panel 100 may be enhanced.

In addition, the sizes of the transistors of the output amplifiers of the data driver 500 may not be increased so that the output speed of the output amplifier may not be decreased, the space may not be limited and a manufacturing cost may be reduced. In addition, the current may not be increased to prevent the decrease of the output speed of the output amplifier so that the power consumption may be reduced.

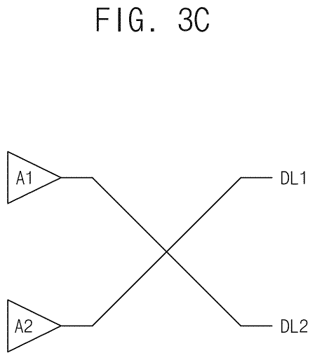

FIG. 4 is a block diagram illustrating an embodiment of a display panel 100, a data driver 500 and an offset apparatus 600A of a display system according to the inventive concept.

The display system in the illustrated embodiment is substantially the same as the display system of the previous embodiment explained referring to FIGS. 1 to 3C except that the offset apparatus further includes an offset determiner. Thus, the same reference numerals will be used to refer to the same or like parts as those described in the previous embodiment of FIGS. 1 to 3C and any repetitive explanation concerning the above elements will be omitted.

Referring to FIGS. 1 to 3A and 4, the offset apparatus 600A may include an offset measurer 610 and an offset determiner 620.

The offset measurer 610 receives a sensing voltage VTEST from the data driver 500 and measures offsets of the output amplifiers A1, A2, . . . , AN of the data driver 500 based on the sensing voltage VTEST.

The offset determiner 620 may receive the offsets ROS of the output amplifiers A1, A2, . . . , AN from the offset measurer 610 and may determine whether the offsets ROS are outside a predetermined tolerance range.

In the illustrated embodiment, the offset measurer 610 may measure the offsets ROS of all of the output amplifiers A1, A2, . . . , AN of the data driver 500. The offset storer 550 may store only the offset OS of the output amplifier which is outside the predetermined tolerance range among the offsets ROS of all of the output amplifiers A1, A2, . . . , AN of the data driver 500.

The offset storer 550 stores only the offset OS of the output amplifier which is outside the predetermined tolerance range among the offsets ROS of all of the output amplifiers A1, A2, . . . , AN of the data driver 500 so that a size of a memory may be reduced and a manufacturing cost of the display apparatus may be reduced.

In the illustrated embodiment, the offset apparatus 600A may be an external apparatus independent from the display apparatus. The offset apparatus 600A may be a test apparatus for a test of the data driver 500.

The data driver 500 may include an offset storer 550 storing the offsets OS of the output amplifiers A1, A2, . . . , AN and an offset compensator 560 receiving the offsets OS of the output amplifiers A1, A2, . . . , AN and compensating the data signal DATA based on the offsets OS.

In the illustrated embodiment, the offset storer 550 may receive the offsets OS of the output amplifiers A1, A2, . . . , AN from the offset determiner 620.

In the illustrated embodiment, to compensate the offset differences of the output amplifiers of the data driver 500, the offsets of all output amplifiers of the data driver 500 may be measured, the offsets of some output amplifiers are stored and the data signals DATA may be compensated based on the stored offsets.

The offset differences are compensated so that the vertical line defect of the display panel 100 may be prevented and the display quality of the display panel 100 may be enhanced.

In addition, the sizes of the transistors of the output amplifiers of the data driver 500 may not be increased so that the output speed of the output amplifier may not be decreased, the space may not be limited and a manufacturing cost may be reduced. In addition, the current may not be increased to prevent the decrease of the output speed of the output amplifier so that the power consumption may be reduced.

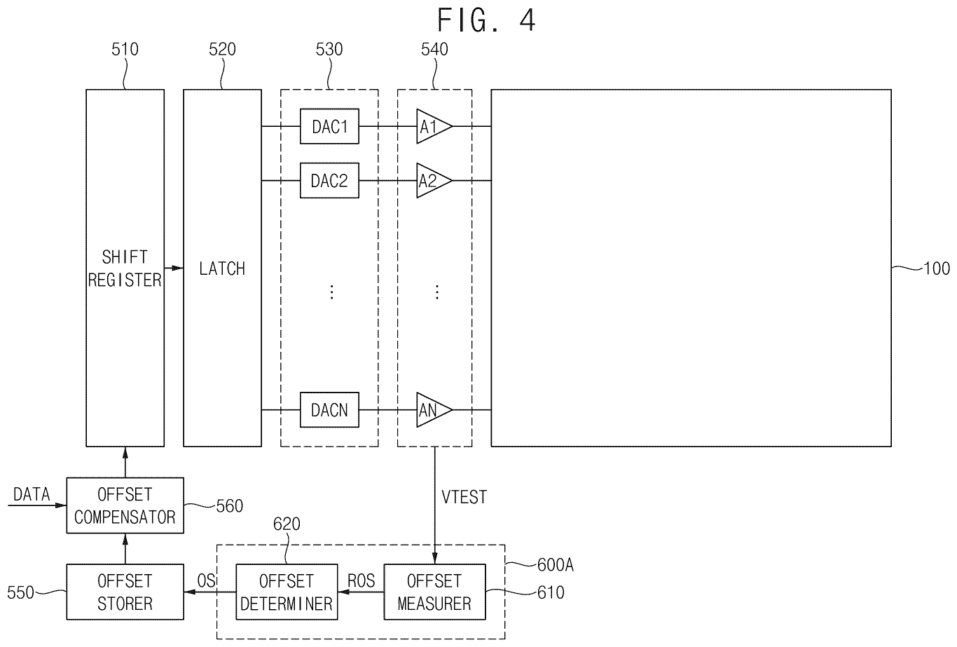

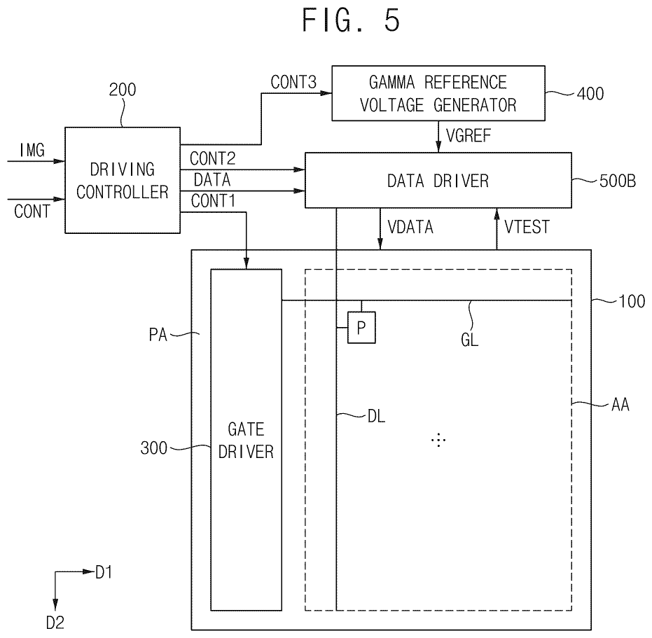

FIG. 5 is a block diagram illustrating an embodiment of a display apparatus according to the inventive concept. FIG. 6 is a block diagram illustrating a display panel 100 and a data driver 500B of FIG. 5.

The display apparatus in the illustrated embodiment is substantially the same as the display apparatus of the previous embodiment explained referring to FIGS. 1 to 3C except that the offset measurer is disposed in the data driver. Thus, the same reference numerals will be used to refer to the same or like parts as those described in the previous embodiment of FIGS. 1 to 3C and any repetitive explanation concerning the above elements will be omitted.

Referring to FIGS. 3A to 3C, 5 and 6, the display apparatus includes a display panel 100 and a display panel driver. The display panel driver drives the display panel 100. The display panel driver includes a driving controller 200, a gate driver 300, a gamma reference voltage generator 400 and a data driver 500B.

The data driver 500B may include the offset measurer 545. The offset measurer 545 receives a sensing voltage VTEST from the data driver 500B and measures offsets of output amplifiers A1, A2, . . . , AN of the data driver 500B based on the sensing voltage VTEST.

In an embodiment, the offset measurer 545 may include a high-resolution analog to digital converter, for example. In an embodiment, the offset measurer 545 may be sequentially connected to the output amplifiers A1, A2, . . . , AN and measure offsets of the output amplifiers A1, A2, . . . , AN, for example.

In the illustrated embodiment, the offset measurer 545 may be disposed in the data driver 500B of the display apparatus.

In a driving mode, the data driver 500B may output the data voltage VDATA to the display panel 100. In a measuring mode, the data driver 500B may output the sensing voltage VTEST to the display panel 100. In the measuring mode, the offset measurer 545 may receive the sensing voltage VTEST.

In the illustrated embodiment, the offset measurer 545 is disposed in the data driver 500B of the display apparatus so that the offset measurer 545 may receive the sensing voltage VTEST in real time when the display apparatus is operating. In an embodiment, the offset measurer 545 may receive the sensing voltage VTEST during a turn-on or turn-off period of the display apparatus, for example. In an embodiment, the offset measurer 545 may be sequentially connected to the output amplifiers A1, A2, . . . , AN and measure offsets of the output amplifiers A1, A2, . . . , AN, for example.

The data driver 500B may further include an offset storer 550 storing the offsets OS of the output amplifiers A1, A2, . . . , AN and an offset compensator 560 receiving the offsets OS of the output amplifiers A1, A2, . . . , AN and compensating the data signal DATA based on the offsets OS.

In the illustrated embodiment, the offset storer 550 may receive the offsets OS of the output amplifiers A1, A2, . . . , AN from the offset measurer 545.

The offset compensator 560 may receive the data signal DATA from the driving controller 200. The offset compensator 560 may operate an offset compensation value having a digital type and the data signal DATA having a digital type to compensate the data signal DATA.

In the illustrated embodiment, the offset measurer 545 may measure the offsets OS of all of the output amplifiers A1, A2, . . . , AN of the data driver 500B. The offset storer 550 may store the offsets OS of all of the output amplifiers A1, A2, . . . , AN of the data driver 500B.

The data driver 500B may further include a shift register 510 receiving the compensated data signal DATA and shifting the compensated data signal DATA, a latch 520 temporally storing the compensated data signal DATA, a digital-to-analog converting circuit 530 converting the compensated data signal DATA to the data voltage VDATA having an analog type, and an output amplifying circuit 540 outputting the data voltage VDATA to the display panel 100.

The output amplifying circuit 540 may include the first to N-th output amplifiers A1, A2, . . . , AN. The digital-to-analog converting circuit 530 may include first to N-th digital-to-analog converters DAC1, DAC2, . . . , DACN respectively corresponding to the first to N-th output amplifiers A1, A2, . . . , AN.

The offset compensator 560 may output the compensated data signal DATA to the shift register 510. The offset measurer 545 may receive the sensing voltage VTEST from the output amplifying circuit 540.

In the illustrated embodiment, the data driver 500B may include the first output amplifier A1, the second output amplifier A2, the first data line DL1, the second data line DL2, an 1-1 switch SW11 disposed between the first output amplifier A1 and the first data line DL1, an 1-2 switch SW12 disposed between the second output amplifier A2 and the second data line DL2, a 2-1 switch SW21 disposed between the second output amplifier A2 and the first data line DL1 and a 2-2 switch SW22 disposed between the second output amplifier A2 and the second data line DL2.

As shown in FIG. 3B, the first output amplifier A1 may be connected to the first data line DL1 and the second output amplifier A2 may be connected to the second data line DL2 in the first mode.

As shown in FIG. 3C, the first output amplifier A1 may be connected to the second data line DL2 and the second output amplifier A2 may be connected to the first data line DL1 in the second mode.

The first mode and the second mode may alternately operate. When the first mode and the second mode alternately operate, an offset component of the first output amplifier A1 and an offset component of the second output amplifier A2 may be reflected to the data voltage outputted to the first data line DL1 and the second data line DL2 in a time division manner. Thus, an average of the data voltage of the first data line DL1 and an average of the data voltage of the second data line DL2 may not have difference. As explained above, a luminance difference of a display image between two data lines DL1 and DL2 due to the offsets of two output amplifiers A1 and A2 may be removed so that the display quality of the display panel 100 may be enhanced.

In the illustrated embodiment, to compensate the offset differences of the output amplifiers of the data driver 500B, the offsets of all output amplifiers of the data driver 500B may be measured, the offsets of all output amplifiers are stored and the data signals DATA may be compensated based on the stored offsets.

The offset differences are compensated so that the vertical line defect of the display panel 100 may be prevented and the display quality of the display panel 100 may be enhanced.

In addition, the sizes of the transistors of the output amplifiers of the data driver 500B may not be increased so that the output speed of the output amplifier may not be decreased, the space may not be limited and a manufacturing cost may be reduced. In addition, the current may not be increased to prevent the decrease of the output speed of the output amplifier so that the power consumption may be reduced.

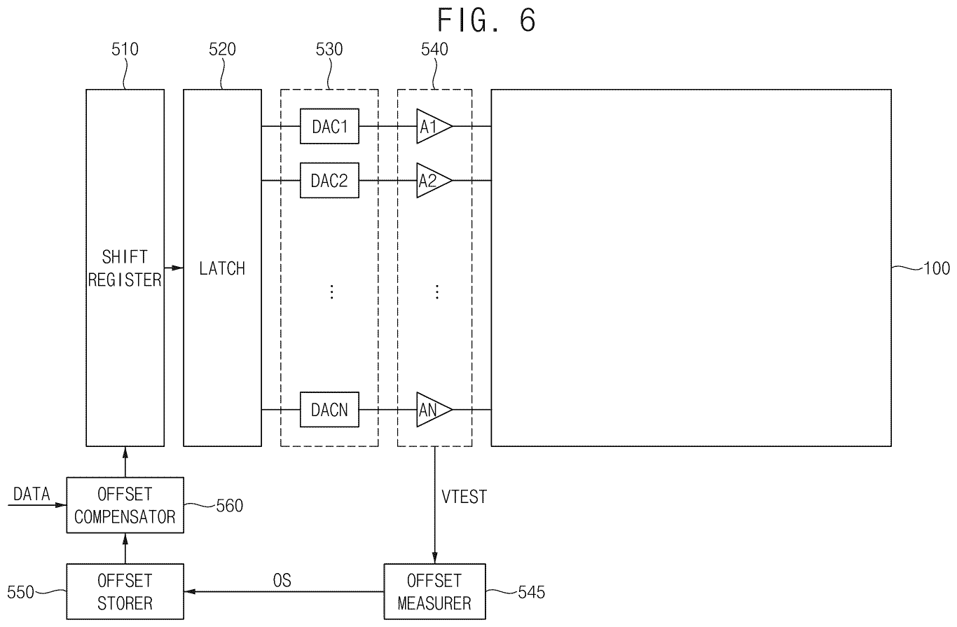

FIG. 7 is a block diagram illustrating an embodiment of a display panel 100 and a data driver 500B of a display apparatus according to the inventive concept.

The display system in the illustrated embodiment is substantially the same as the display system of the previous embodiment explained referring to FIGS. 5 and 6 except that the data driver further includes an offset determiner. Thus, the same reference numerals will be used to refer to the same or like parts as those described in the previous embodiment of FIGS. 5 and 6 and any repetitive explanation concerning the above elements will be omitted.

Referring to FIGS. 3A to 3C, 5 and 7, the data driver 500B may further include an offset determiner 547 receiving the offsets ROS of the output amplifiers A1, A2, . . . , AN from the offset measurer 545 and determining whether the offsets ROS are outside a predetermined tolerance range.

In the illustrated embodiment, the offset measurer 545 may measure the offsets ROS of all of the output amplifiers A1, A2, . . . , AN of the data driver 500B. The offset storer 550 may store only the offset OS of the output amplifier which is outside the predetermined tolerance range among the offsets ROS of all of the output amplifiers A1, A2, . . . , AN of the data driver 500B.

In the illustrated embodiment, the offset measurer 545 and the offset determiner 547 may be disposed in the data driver 500B of the display apparatus.

The offset storer 550 stores only the offset OS of the output amplifier which is outside the predetermined tolerance range among the offsets ROS of all of the output amplifiers A1, A2, . . . , AN of the data driver 500B so that a size of a memory may be reduced and a manufacturing cost of the display apparatus may be reduced.

In the illustrated embodiment, the offset storer 550 may receive the offsets OS of the output amplifiers A1, A2, . . . , AN from the offset determiner 547.

In the illustrated embodiment, to compensate the offset differences of the output amplifiers of the data driver 500B, the offsets of all output amplifiers of the data driver 500B may be measured, the offsets of some output amplifiers are stored and the data signals DATA may be compensated based on the stored offsets.

The offset differences are compensated so that the vertical line defect of the display panel 100 may be prevented and the display quality of the display panel 100 may be enhanced.

In addition, the sizes of the transistors of the output amplifiers of the data driver 500B may not be increased so that the output speed of the output amplifier may not be decreased, the space may not be limited and a manufacturing cost may be reduced. In addition, the current may not be increased to prevent the decrease of the output speed of the output amplifier so that the power consumption may be reduced.

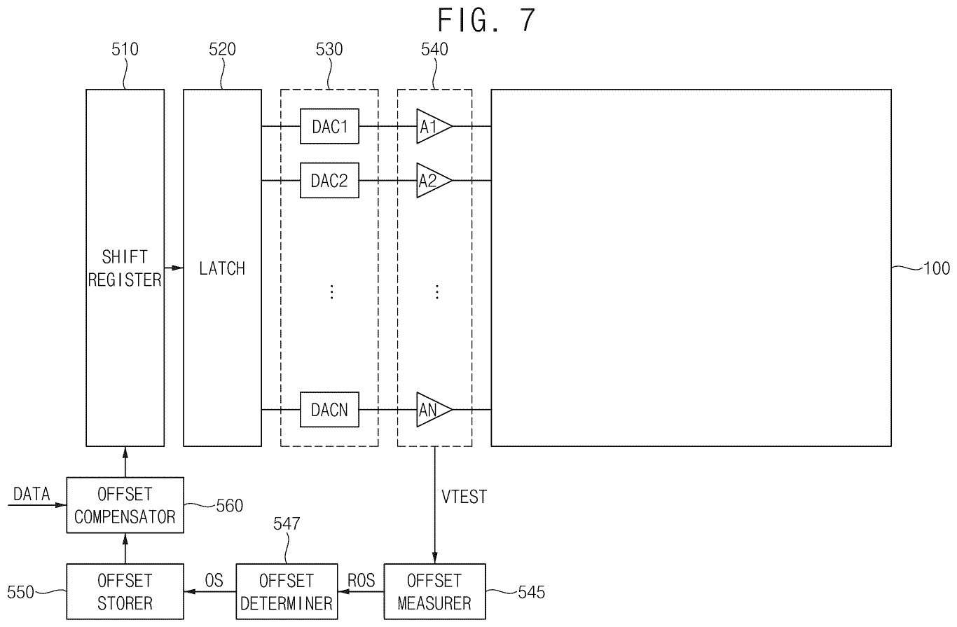

FIG. 8 is a diagram illustrating an embodiment of a display system according to the inventive concept.

Referring to FIG. 8, the display system may include a lens 10, a display apparatus 20 and a housing 30. The display apparatus 20 may be disposed next (adjacent) to the lens 10. The housing 30 may accommodate the lens 10 and the display apparatus 20. Although the lens unit 10 and the display apparatus 20 are accommodated on a first side of the housing 30 in FIG. 8, the inventive concept may not be limited thereto.

In an embodiment, the lens 10 may be accommodated on a first side of the housing 30 and the display apparatus 20 may be accommodated on a second side of the housing 30 opposite to the first side of the housing 30, for example. When the lens 10 and the display apparatus are accommodated on opposite sides with respect to the housing 30, the housing 30 may have a transmitting portion to transmit a light.

In an embodiment, the display system may be a head mounted display system worn on a user's head, for example. Although not shown in drawing figures, the head mounted display system may further include a head band to fix the display system to the user's head.

In an alternative embodiment, the display system may have a form of smart glasses designed as a shape of glasses.

In an embodiment, the display system may be implemented as a virtual reality (“VR”) display system for supporting a virtual reality, for example.

In addition, the display system may be implemented as an augmented reality (“AR”) display system for supporting an AR. The AR display system may have a smartphone shape, a smart glasses shape, a head mounted display shape, etc., but may not be limited to those shapes.

In addition, the display system may be implemented as a mixed reality (“MR”) display system for supporting a MR. The MR display system may have a smartphone shape, a smart glasses shape, a head mounted display shape, etc., but may not be limited to those shapes.

The display apparatus 20 may include a first display panel. The first display panel may be a first-eye display panel (e.g., left-eye display panel) corresponding to a first eye (e.g., left eye) of the user.

The display apparatus 20 may include a second display panel. The second display panel may be a second-eye (e.g., right-eye) display panel corresponding to a second eye (e.g., right eye) of the user.

The lens 10 may include a first-eye lens (e.g., left-eye lens) corresponding to the first-eye display panel and a second-eye (e.g., right-eye) lens corresponding to the second-eye (e.g., right-eye) display panel.

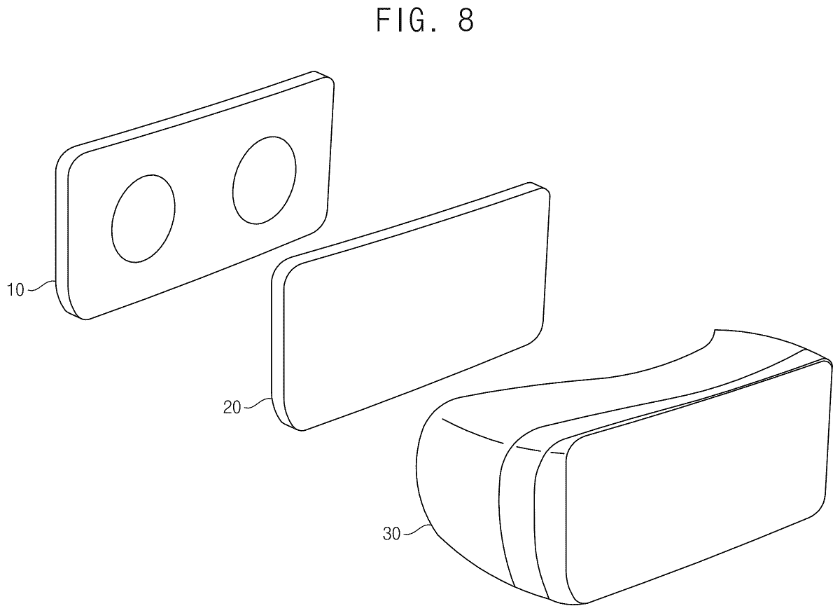

FIG. 9 is a block diagram illustrating the display system of FIG. 8.

Referring to FIGS. 8 and 9, the display system includes a first display panel 101, a second display panel 102, a first data driver 501, a second data driver 502, a first offset apparatus 601 and a second offset apparatus 602.

The first data driver 501 outputs a first data voltage VDATA1 to the first display panel 101. The second data driver 502 outputs a second data voltage VDATA2 to the second display panel 102.

The first offset apparatus 601 may receive a first sensing voltage VTEST1 from the first data driver 501 and measure a first offset OS1 of a first output amplifier of the first data driver 501. The second offset apparatus 602 may receive a second sensing voltage VTEST2 from the second data driver 502 and measure a second offset OS2 of a second output amplifier of the second data driver 502.

The first offset apparatus 601 of the illustrated embodiment may be substantially the same as the offset apparatus 600 of the previous embodiment of FIGS. 1 to 3C. The second offset apparatus 602 of the illustrated embodiment may be substantially the same as the offset apparatus 600 of the previous embodiment of FIGS. 1 to 3C. In an alternative embodiment, the first offset apparatus 601 and the second offset apparatus 602 of the illustrated embodiment may be substantially the same as the offset apparatus 600A of the previous embodiment of FIG. 4.

The first data driver 501 of the illustrated embodiment may be substantially the same as the data driver 500 of the previous embodiment of FIGS. 1 to 3C. The second data driver 502 of the illustrated embodiment may be substantially the same as the data driver 500 of the previous embodiment of FIGS. 1 to 3C.

In an embodiment, at least one of the first data driver 501 and the second data driver 502 may include an offset storer 550 storing at least one of the first offset OS1 of the first output amplifier and the second offset OS2 of the second output amplifier and an offset compensator 560 receiving at least one of the first offset OS1 of the first output amplifier and the second offset OS2 of the second output amplifier and compensating at least one of a first data signal DATA1 and a second data signal DATA2 based on at least one of the first offset OS1 and the second offset OS2, for example.

In the illustrated embodiment, the display system may further include a first driving controller 201 outputting the first data signal DATA1 to the first data driver 501 and a second driving controller 202 outputting the second data signal DATA2 to the second data driver 502.

In an embodiment, the first display panel 101 may be a first-eye (e.g., left-eye) display panel 101 corresponding to a first eye (e.g., left eye) of the user, for example. In an embodiment, the second display panel 102 may be a second-eye (e.g., right-eye) display panel 102 corresponding to a first eye (e.g., left eye) of the user, for example.

Although the first offset apparatus 601 and the second offset apparatus 602 are external apparatuses in the illustrated embodiment like the previous embodiment of FIGS. 1 to 3C and the previous embodiment of FIG. 4, the inventive concept may not be limited thereto. The first offset apparatus 601 and the second offset apparatus 602 may be disposed in the first data driver 501 and the second data driver 502 respectively like the previous embodiment of FIGS. 5 and 6 and the previous embodiment of FIG. 7.

The display system may further include a first gate driver 301 outputting a first gate signal GS1 to the first display panel 101 and a second gate driver 302 outputting a second gate signal GS2 to the second display panel 102.

Although not shown in drawing figures, the display system may further include a first gamma reference voltage generator outputting a first gamma reference voltage to the first data driver 501 and a second gamma reference voltage generator outputting a second gamma reference voltage to the second data driver 502. In an alternative embodiment, the display system may further include a single gamma reference voltage outputting a gamma reference voltage to both of the first data driver 501 and the second data driver 502.

In the illustrated embodiment, to compensate the offset differences of the output amplifiers of the data drivers 501 and 502, the offsets OS1 and OS2 of all output amplifiers of the data drivers 501 and 502 may be measured, the offsets OS1 and OS2 of all output amplifiers or some output amplifiers are stored and the data signals DATA1 and DATA2 may be compensated based on the stored offsets OS1 and OS2.

The offset differences are compensated so that the vertical line defect of the display panels 101 and 102 may be prevented and the display quality of the display panels 101 and 102 may be enhanced.

In addition, the sizes of the transistors of the output amplifiers of the data drivers 501 and 502 may not be increased so that the output speed of the output amplifier may not be decreased, the space may not be limited and a manufacturing cost may be reduced. In addition, the current may not be increased to prevent the decrease of the output speed of the output amplifier so that the power consumption may be reduced.

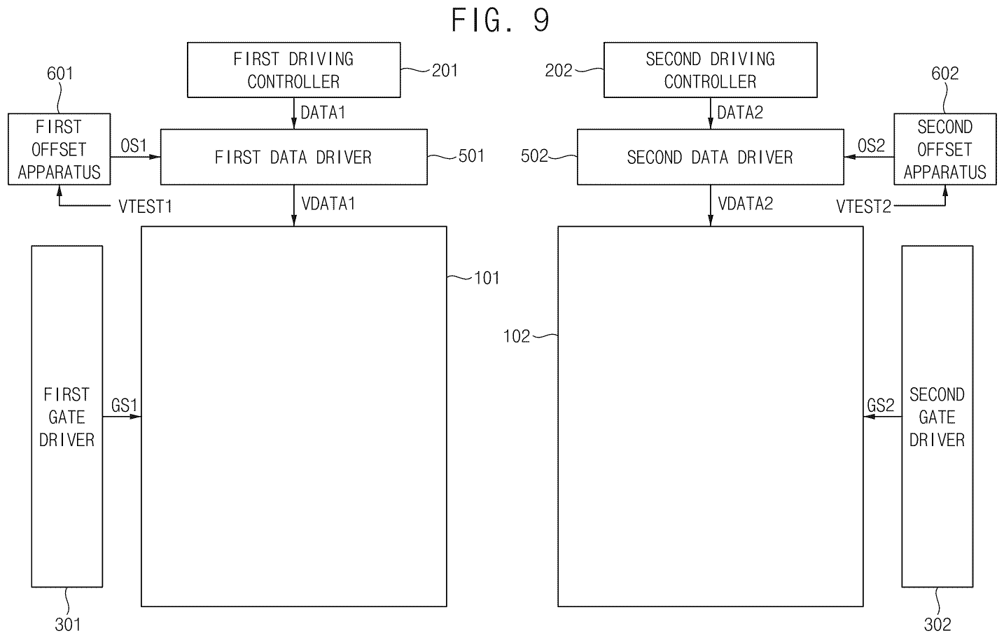

FIG. 10 is a diagram illustrating an embodiment of a display system according to the inventive concept.

The display system in the illustrated embodiment is substantially the same as the display system of the previous embodiment explained referring to FIGS. 8 and 9 except that the display system includes a single driving controller. Thus, the same reference numerals will be used to refer to the same or like parts as those described in the previous embodiment of FIGS. 8 and 9 and any repetitive explanation concerning the above elements will be omitted.

Referring to FIGS. 8 and 10, the display system includes a first display panel 101, a second display panel 102, a first data driver 501, a second data driver 502, a first offset apparatus 601 and a second offset apparatus 602.

The first data driver 501 outputs a first data voltage VDATA1 to the first display panel 101. The second data driver 502 outputs a second data voltage VDATA2 to the second display panel 102.

The first offset apparatus 601 may receive a first sensing voltage VTEST1 from the first data driver 501 and measure a first offset OS1 of a first output amplifier of the first data driver 501. The second offset apparatus 602 may receive a second sensing voltage VTEST2 from the second data driver 502 and measure a second offset OS2 of a second output amplifier of the second data driver 502.

The first offset apparatus 601 of the illustrated embodiment may be substantially the same as the offset apparatus 600 of the previous embodiment of FIGS. 1 to 3C. The second offset apparatus 602 of the illustrated embodiment may be substantially the same as the offset apparatus 600 of the previous embodiment of FIGS. 1 to 3C. In an alternative embodiment, the first offset apparatus 601 and the second offset apparatus 602 of the illustrated embodiment may be substantially the same as the offset apparatus 600A of the previous embodiment of FIG. 4.

The first data driver 501 of the illustrated embodiment may be substantially the same as the data driver 500 of the previous embodiment of FIGS. 1 to 3C. The second data driver 502 of the illustrated embodiment may be substantially the same as the data driver 500 of the previous embodiment of FIGS. 1 to 3C.

In an embodiment, at least one of the first data driver 501 and the second data driver 502 may include an offset storer 550 storing at least one of the first offset OS1 of the first output amplifier and the second offset OS2 of the second output amplifier and an offset compensator 560 receiving at least one of the first offset OS1 of the first output amplifier and the second offset OS2 of the second output amplifier and compensating at least one of a first data signal DATA1 and a second data signal DATA2 based on at least one of the first offset OS1 and the second offset OS2, for example.

In the illustrated embodiment, the display system may further include a driving controller 200 outputting the first data signal DATA1 to the first data driver 501 and the second data signal DATA2 to the second data driver 502.

In an embodiment, the first display panel 101 may be a first-eye (e.g., left-eye) display panel 101 corresponding to a first eye (e.g., left eye) of the user, for example. In an embodiment, the second display panel 102 may be a second-eye (e.g., right-eye) display panel 102 corresponding to a first eye (e.g., left eye) of the user, for example.

Although the first offset apparatus 601 and the second offset apparatus 602 are external apparatuses in the illustrated embodiment like the previous embodiment of FIGS. 1 to 3C and the previous embodiment of FIG. 4, the inventive concept may not be limited thereto. The first offset apparatus 601 and the second offset apparatus 602 may be disposed in the first data driver 501 and the second data driver 502 respectively like the previous embodiment of FIGS. 5 and 6 and the previous embodiment of FIG. 7.

In the illustrated embodiment, to compensate the offset differences of the output amplifiers of the data drivers 501 and 502, the offsets OS1 and OS2 of all output amplifiers of the data drivers 501 and 502 may be measured, the offsets OS1 and OS2 of all output amplifiers or some output amplifiers are stored and the data signals DATA1 and DATA2 may be compensated based on the stored offsets OS1 and OS2.

The offset differences are compensated so that the vertical line defect of the display panels 101 and 102 may be prevented and the display quality of the display panels 101 and 102 may be enhanced.

In addition, the sizes of the transistors of the output amplifiers of the data drivers 501 and 502 may not be increased so that the output speed of the output amplifier may not be decreased, the space may not be limited and a manufacturing cost may be reduced. In addition, the current may not be increased to prevent the decrease of the output speed of the output amplifier so that the power consumption may be reduced.

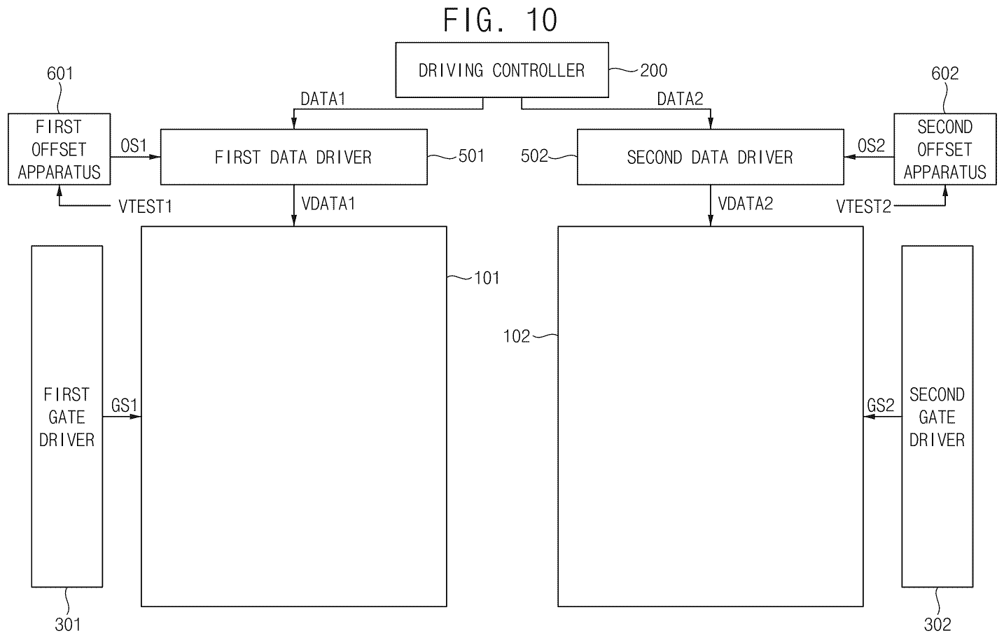

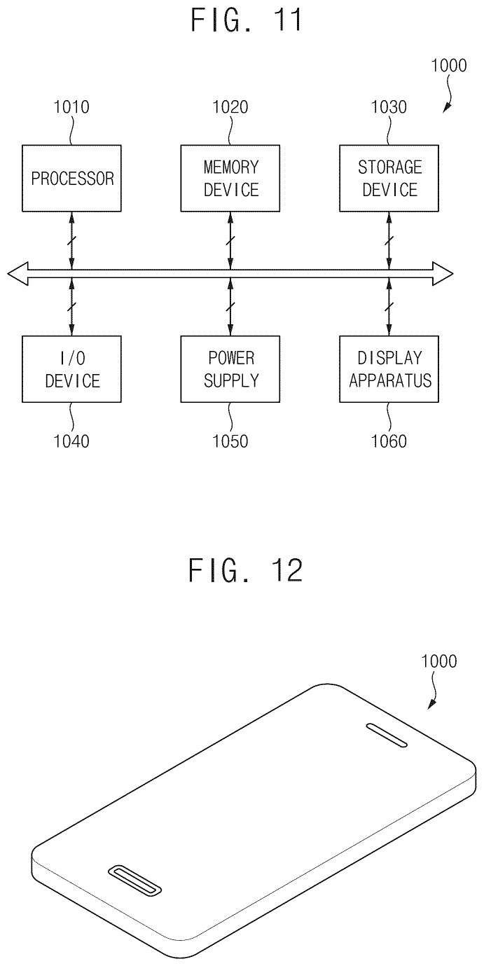

FIG. 11 is a block diagram illustrating an embodiment of an electronic apparatus 1000 according to the inventive concept. FIG. 12 is a diagram illustrating an embodiment in which the electronic apparatus 1000 of FIG. 11 is implemented as a smartphone.

Referring to FIGS. 11 and 12, the electronic apparatus 1000 may include a processor 1010, a memory device 1020, a storage device 1030, an input/output (“I/O”) device 1040, a power supply 1050, and a display apparatus 1060. Here, the display apparatus 1060 may be the display apparatus of FIG. 1. In addition, the electronic apparatus 1000 may further include a plurality of ports for communicating with a video card, a sound card, a memory card, a universal serial bus (“USB”) device, other electronic apparatuses, etc.

In an embodiment, as illustrated in FIG. 12, the electronic apparatus 1000 may be implemented as a smartphone. However, the electronic apparatus 1000 is not limited thereto. In an embodiment, the electronic apparatus 1000 may be implemented as a television, a monitor, a cellular phone, a video phone, a smart pad, a smart watch, a tablet personal computer (“PC”), a car navigation system, a laptop, a head mounted display (“HMD”) device, or the like, for example.

The processor 1010 may perform various computing functions or various tasks. The processor 1010 may be a micro-processor, a central processing unit (“CPU”), an application processor (“AP”), or the like. The processor 1010 may be coupled to other components via an address bus, a control bus, a data bus, etc. Further, the processor 1010 may be coupled to an extended bus such as a peripheral component interconnection (“PCI”) bus.

The processor 1010 may output the input image data IMG and the input control signal CONT to the driving controller 200 of FIG. 1.

The memory device 1020 may store data for operations of the electronic apparatus 1000. In an embodiment, the memory device 1020 may include at least one non-volatile memory device such as an erasable programmable read-only memory (“EPROM”) device, an electrically erasable programmable read-only memory (“EEPROM”) device, a flash memory device, a phase change random access memory (“PRAM”) device, a resistance random access memory (“RRAM”) device, a nano floating gate memory (“NFGM”) device, a polymer random access memory (“PoRAM”) device, a magnetic random access memory (“MRAM”) device, a ferroelectric random access memory (“FRAM”) device, or the like and/or at least one volatile memory device such as a dynamic random access memory (“DRAM”) device, a static random access memory (“SRAM”) device, a mobile DRAM device, or the like, for example.

The storage device 1030 may include a solid state drive (“SSD”) device, a hard disk drive (“HDD”) device, a compact disc read-only memory (“CD-ROM”) device, or the like. The I/O device 1040 may include an input device such as a keyboard, a keypad, a mouse device, a touch-pad, a touch-screen, or the like and an output device such as a printer, a speaker, or the like. In some embodiments, the display apparatus 1060 may be included in the I/O device 1040. The power supply 1050 may provide power for operations of the electronic apparatus 1000. The display apparatus 1060 may be coupled to other components via the buses or other communication links.

By the embodiments of the display system, the display apparatus and the electronic apparatus, the display quality of the display panel may be enhanced.

The foregoing is illustrative of the inventive concept and is not to be construed as limiting thereof. Although a few embodiments of the inventive concept have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims. In the claims, means-plus-function clauses are intended to cover the structures described herein as performing the recited function and not only structural equivalents but also equivalent structures. Therefore, it is to be understood that the foregoing is illustrative of the inventive concept and is not to be construed as limited to the illustrative embodiments disclosed, and that modifications to the disclosed embodiments, as well as other embodiments, are intended to be included within the scope of the appended claims. The inventive concept is defined by the following claims, with equivalents of the claims to be included therein.

What is claimed is:

1. A display system comprising:
a display panel;
a data driver configured to output a data voltage to the display panel, the data driver comprising:
an offset storer; and
an offset compensator; and
an offset apparatus including an offset measurer configured to receive a sensing voltage from the data driver and to measure offsets of output amplifiers of the data driver,
wherein the offset storer is configured to store the offsets of the output amplifiers, and
the offset compensator is configured to receive the offsets of the output amplifiers and to compensate a data signal.

2. The display system of claim 1, wherein the offset measurer is configured to measure the offsets of all of the output amplifiers of the data driver, and
wherein the offset storer is configured to store the offsets of all of the output amplifiers of the data driver.

3. The display system of claim 1, wherein the offset apparatus further comprises:
an offset determiner configured to receive the offsets of the output amplifiers from the offset measurer and determine whether the offsets are outside a predetermined tolerance range.

4. The display system of claim 3, wherein the offset measurer is configured to measure the offsets of all of the output amplifiers of the data driver, and
wherein the offset storer is configured to store only an offset of an output amplifier which is outside the predetermined tolerance range among the offsets of all of the output amplifiers of the data driver.

5. The display system of claim 1, wherein the data driver further comprises:
a shift register configured to receive a compensated data signal;
a latch configured to temporally store the compensated data signal;
a digital-to-analog converting circuit configured to convert the compensated data signal to the data voltage having an analog type; and
an output amplifying circuit configured to output the data voltage to the display panel,
wherein the offset compensator is configured to output the compensated data signal to the shift register, and
wherein the offset measurer is configured to receive the sensing voltage from the output amplifying circuit.

6. The display system of claim 1, wherein the data driver further comprises:
a first output amplifier;
a second output amplifier;
a first data line;
a second data line;
an 1-1 switch disposed between the first output amplifier and the first data line;
an 1-2 switch disposed between the first output amplifier and the second data line;
a 2-1 switch disposed between the second output amplifier and the first data line; and
a 2-2 switch disposed between the second output amplifier and the second data line.

7. The display system of claim 6, wherein the first output amplifier is connected to the first data line and the second output amplifier is connected to the second data line in a first mode,
wherein the first output amplifier is connected to the second data line and the second output amplifier is connected to the first data line in a second mode, and
wherein the first mode and the second mode alternately operate.

8. A electronic apparatus comprising:
a display panel;
a data driver configured to output a data voltage to the display panel, the data driver comprising:
an offset measurer configured to receive a sensing voltage from output amplifiers and to measure offsets of the output amplifiers;
an offset storer configured to store the offsets of the output amplifiers; and
an offset compensator configured to receive the offsets of the output amplifiers and to compensate a data signal;
a driving controller configured to control the data driver; and
a processor configured to output input image data and an input control signal to the driving controller.

9. The electronic apparatus of claim 8, wherein the offset measurer is configured to measure the offsets of all of the output amplifiers of the data driver, and
wherein the offset storer is configured to store the offsets of all of the output amplifiers of the data driver.

10. The electronic apparatus of claim 8, wherein the data driver further comprises:
an offset determiner configured to receive the offsets of the output amplifiers from the offset measurer and determine whether the offsets are outside a predetermined tolerance range.

11. The electronic apparatus of claim 10, wherein the offset measurer is configured to measure the offsets of all of the output amplifiers of the data driver, and
wherein the offset storer is configured to store only an offset of an output amplifier which is outside the predetermined tolerance range among the offsets of all of the output amplifiers of the data driver.

12. The electronic apparatus of claim 8, wherein the data driver is configured to output the data voltage to the display panel in a driving mode,
wherein the data driver is configured to output the sensing voltage to the display panel in a measuring mode, and
wherein the offset measurer is configured to receive the sensing voltage in the measuring mode.

13. The electronic apparatus of claim 8, wherein the data driver further comprises:
a shift register configured to receive a compensated data signal;
a latch configured to temporally store the compensated data signal;
a digital-to-analog converting circuit configured to convert the compensated data signal to the data voltage having an analog type; and
an output amplifying circuit configured to output the data voltage to the display panel,
wherein the offset compensator is configured to output the compensated data signal to the shift register, and
wherein the offset measurer is configured to receive the sensing voltage from the output amplifying circuit.

14. The electronic apparatus of claim 8, wherein the data driver further comprises:
a first output amplifier;
a second output amplifier;
a first data line;
a second data line;
an 1-1 switch disposed between the first output amplifier and the first data line;
an 1-2 switch disposed between the first output amplifier and the second data line;
a 2-1 switch disposed between the second output amplifier and the first data line; and
a 2-2 switch disposed between the second output amplifier and the second data line.

15. The electronic apparatus of claim 14, wherein the first output amplifier is connected to the first data line and the second output amplifier is connected to the second data line in a first mode,
wherein the first output amplifier is connected to the second data line and the second output amplifier is connected to the first data line in a second mode, and
wherein the first mode and the second mode alternately operate.

16. A display system comprising:
a first display panel;
a second display panel;
a first data driver configured to output a first data voltage to the first display panel;
a second data driver configured to output a second data voltage to the second display panel, at least one of the first data driver and the second data driver comprising:
an offset storer; and
an offset compensator;
a first offset apparatus configured to receive a first sensing voltage from the first data driver and to measure a first offset of a first output amplifier of the first data driver; and
a second offset apparatus configured to receive a second sensing voltage from the second data driver and to measure a second offset of a second output amplifier of the second data driver,
wherein the offset storer is configured to store at least one of the first offset of the first output amplifier and the second offset of the second output amplifier; and
the offset compensator is configured to receive at least one of the first offset of the first output amplifier and the second offset of the second output amplifier and to compensate at least one of a first data signal and a second data signal.

17. The display system of claim 16, further comprising:
a first driving controller configured to output the first data signal to the first data driver; and
a second driving controller configured to output the second data signal to the second data driver.

18. The display system of claim 16, further comprising:
a driving controller configured to output the first data signal to the first data driver and the second data signal to the second data driver.

19. The display system of claim 16, wherein the first display panel is a first-eye display panel corresponding to a first eye of a user, and
wherein the second display panel is a second-eye display panel corresponding to a second eye of the user.

20. The display system of claim 19, further comprising:
a first-eye lens corresponding to the first-eye display panel; and
a second-eye lens corresponding to the second-eye display panel.
